(19) United States
(12) Patent Application Publication
(10) Pub. No.: US 2005/0030912 A1
(43) Pub. Date: Feb. 10, 2005

(54) Use of hybrid (HW/DSP/MCU/SW) architectures for powerline OFDM communication field

(75) Inventors: Oleg Logvinov, East Brunswick, NJ (US); Lawrence F. Durfee, Washington, NJ (US); Brion Ebert, Easton, PA (US)

Correspondence Address: NORRIS, MCLAUGHLIN & MARCUS, 875 THIRD AVE, 18TH FLOOR, NEW YORK, NY, 10022, US

(73) Assignee: ENIKIA L.L.C., North Plainfield, NJ (US)

(21) Appl. No.: 10/646,413

(22) Filed: Aug. 21, 2003

Related U.S. Application Data
(60) Provisional application No. 60/405,227, filed on Aug. 22, 2002.

(51) Int. Cl. H04L 5/14

(52) U.S. Cl. 370/295

(57) ABSTRACT

One embodiment of this invention is an OFDM PLC transceiver ASIC built with one or more MCU's (optional), DSP's and hardwired logic blocks, based on this architecture, that would be used for in-home, MDU and access applications having three separate program loads. Once the program has completed loading, the transceiver would operate and meet all the requirements (technical and regulatory standards) for that application segment.

### RELATED APPLICATIONS

The benefit of priority of the provisional application 60/405,277 filed on Aug. 22, 2002 in the names of the inventors, is hereby claimed.

### BACKGROUND OF THE INVENTION

1. Field of the Invention

The present invention relates to high-speed data communication using Orthogonal Frequency Division Multiplexing (OFDM) techniques as used in powerline communications (PLC). PLC technology can be applied in many different situations (e.g., in-home/office, access, etc.) and this patent applies to all PLC application segments.

2. Description of the Related Art

The use of PLC (powerline communications) technology is very attractive because there is no need to install new wires to communicate between stations. Existing power wiring in homes and business as well as the wires used to carry power in the electric power distribution grid are all capable of supporting high-speed data communications. As can be easily been appreciated, there are several applications for which such wiring is particularly relevant, such as a first application, which is an in-home, or in-business application and/or a home or business access application, a second application, which is for multiple dwelling units, such as apartment buildings, hotels and motels, and a third application can be applied to any use of OFDM PLC in any application segment or segments on the electric power grid.

Each of these different application areas represents a different set of design parameters, but all can use OFDM for implementing PLC transceivers. Each of these different areas is in a different standardization condition and government regulatory stage. In-home PLC standardization, for one example, is well along with the formation of an industrial alliance (HomePlug) and the subsequent release of their formal PLC specification. Other segments of PLC applications, such as access, are just starting to become established and so the specifications are less rigid.

Using a single, flexible and programmable architecture for the design of PLC transceivers for all these applications segments would be highly desirable. A single module (e.g., ASIC or multi-ASIC chip set) that could be customized through programming would mean that the module cost could be amortized over the volumes in all segments. This would result in a significant cost reduction for these devices.

The programmable flexibility would mean that changes in standards, regulatory requirements, product patches, product new features and product enhancements could mostly be accommodated by installing new software instead of with costly and time consuming hardware modifications (e.g., revising ASIC logic usually means manufacturing a new foundry mask set for the device).

This invention defines a single architecture for constructing OFDM PLC transceivers composed of three elements: hardwired logic (e.g., ASIC, ASIC with FPGA, FPGA, etc.), DSP code, and MCU (microcontroller unit) code (the MCU is an optional element). The resultant OFDM PLC transceivers will operate in many different PLC application segments by applying the appropriate software load. Note that each application will require additional analog components, which may be application unique. The flexibility of the architecture allows a single hardware device to be reprogrammed (tuned) to the target PLC application segment.

### SUMMARY OF THE INVENTION

The present invention defines an architecture for OFDM PLC transceivers that uses hardwired logic, DSP controllers and optional MCU devices. The architecture gives great flexibility in the implementation such that a single module (e.g., ASIC, ASIC set, FPGA, etc.) can be used in significantly different PLC application segments (e.g., in-home, MDU, access, etc.) by changing only the software load for each application. The invention describes a flexible inter-block communication structure that allows active reconfiguration to change the data flow.

### BRIEF DESCRIPTION OF THE FIGURES

FIG. 1 Illustrates the functional blocks in a typical OFDM PLC transceiver.

FIG. 2 illustrates the elements of the OFDM Transceiver Architecture;

FIG. 3 illustrates a generalized Architecture;

FIG. 4 illustrates an example implementation;

FIG. 5 illustrates an example transmit data flow;

FIG. 6 illustrates an example case of FIG. 5, a revised transmit data flow MDU Operation)

FIG. 7 illustrates and example of a dual-bus (control and data) and multi-port based architecture

### DETAILED DESCRIPTION OF THE INVENTION

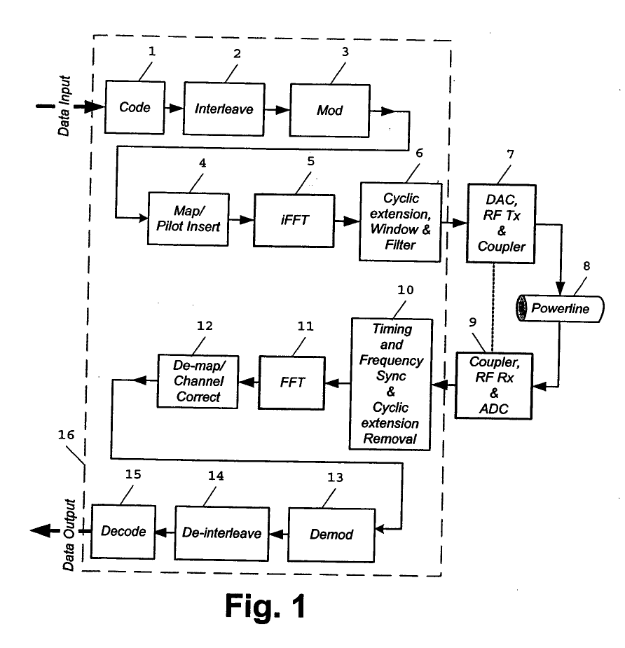

FIG. 1 shows all the necessary and sufficient functional blocks needed to build a PLC transceiver. This figure illustrates the PHY layer blocks in a typical OFDM PLC transceiver. The present invention involves the elements shown in the enclosed dashed box (16) of this figure. The blocks outside the dashed box are mixed signal elements that are beyond the scope of this patent and will not be discussed in detail.

The PLC transceiver can be divided into two sections—transmitter and receiver. The following is a summary list of blocks for each section (numbers in the list below refer to FIG. 1):

| Transmitter | | | Receiver | |
|---|---|---|---|---|
| Serial data input | | | Serial data output | |
| 1 | Code | | 15 | Decode |
| 2 | Interleave | | 14 | De-interleave |
| 3 | Mod | | 13 | De-mod |
| 4 | Map/Pilot insert | | 12 | De-map/Channel correct |
| 5 | iFFT | | 11 | FFT |
| 6 | Cyclic extension, | | 10 | Timing and frequency sync & |
| | windowing & filtering | | | cyclic Extension removal |
| 7 | DAC, | 8 Powerline | 9 | ADC, |
| | RF Tx & coupler → | Channel | | → Coupler, & RF Rx |

1. Functional Blocks in a OFDM PLC Transceiver

One of the first steps an OFDM PLC receiver must perform in order to extract data from the powerline channel ((8), in FIG. 1), is to perform synchronization. Two types of synchronization are required: OFDM symbol boundary identification/timing and sub-carrier frequency/phase offset estimation/correction. The highlighted/italicized blocks in the list in the introduction above are directly involved in synchronization.

The transmitter, in some OFDM implementations (e.g., 802.11a), inserts several fixed pilots (performed by block (4): Map/Pilot Insert) on particular sub-channels to be used by the receivers channel estimator (sub-channel time and frequency estimations). While on other implementations (notably HPA), block (4) enables and disables sub-channels in cooperation with remote units (known as tone mapping). Part of the function of block (6) (Cyclic Extension, Windowing and Filtering) is to insert preset synchronization information before the transmission of the data block to be used by the receiver to estimate the timing and frequency offset of each OFDM symbol.

The two key receiver blocks, block (10) (Timing and Frequency Sync & Cyclic Extension Removal) and block (12) (De-map), correspond to block (6) and block (4) respectively on the transmit side and are responsible for, among other tasks, synchronization.

PLC transceivers use forward error correcting (FEC) schemes to account for errors introduced by the noisy powerline channel. The FEC process adds redundancy to the data that is then used by the receiver to correct errors. The incoming data is coded with FEC as performed by block (1). The decoding process is performed in the corresponding block (15). Examples of FEC schemes used in PLC systems are Reed-Solomon and convolutional/Viterbi, which may be punctured to adjust the effective throughput. PLC transceivers use different FEC schemes depending on the changing condition of the communications channel to which they are attached.

Interleaving (2) and de-interleaving (14) are performed by PLC transceivers to aid the FEC process by moving adjacent data bits to non-adjacent carriers. In this way the loss of several adjacent carriers will mean the corresponding lost data bits will be spread across several different FEC blocks and there will be a higher probability that the errors can be corrected. PLC transceivers select an interleaving option based on the prevailing conditions of the powerline channel.

The digital data must be processed (modulation) so that the results can be transmitted on the channel as an analog signal and that is the function of block (3) (the equivalent receiver block is (13)). PLC transceivers need to use multiple modulation schemes at different times so as to adapt to the changing conditions found on the powerline channel. Typical modulation methods include Binary Phase Shift Keying (BPSK), Quadrature Phase Shift Keying (QPSK), various forms of Quadrature Amplitude Modulation (QAM), as well as many others.

The Inverse Fast Fourier Transform (iFFT, block (5)) is used to convert the multi-carrier modulated data (frequency domain) into a sequential data stream (time domain) that can be sent to a digital to analog converter (DAC, part of block (7)) whereby the DAC analog output signal is eventually applied to the powerline channel.

Blocks (7) and (9) contain mostly analog components that function to place the transmit signal on the channel and recover received signals from the channel.

The previous block by block discussions clearly shows that for any given PLC application segment (e.g., first and second type of application, etc.), the PLC transceiver must be highly adaptive to utilize the available bandwidth in the most optimal manner. That is, the transceiver continually monitors channel conditions and selects different operational parameters aimed at utilizing the available channel bandwidth in the most efficient manner. Therefore, any PLC transceiver needs to have a fair amount of flexibility but this invention expands the overall flexibility to allow the same transceiver to be used in a wider range of PLC application segments.

Elements of the Architecture

FIG. 2 shows the three architectural elements (within the dashed box, #205) used to construct PLC transceivers (200), Hardwire logic (220), DSP (215) and optional MCU (230). The other important element is the data exchange memory (227). The complete PLC transceiver also includes the AFE (210) that connects to the powerline (225). The OFDM PLC architecture for this invention is shown in FIG. 2. Each of the blocks mentioned in the previous section (as shown in FIG. 1) would be implemented for this invention in one of three ways: hardwire logic (FIG. 2, (220)), code running on a DSP (215) or optionally, code running on an MCU (230).

Hardwired logic means digital logic implemented in an ASIC, an FPGA or in an FPGA embedded in an ASIC. In each of these cases, the logic would be designed to be flexible with programmable options. For example, a shift register can easily be designed to have a programmable length with associated processing blocks that accept programmable bit taps from the shift register. A hardwired FFT block, for another example, could be designed to have several, programmable, sizes (e.g., 256-point FFT, 1024 point FFT, etc.). Therefore, even though the blocks are labeled as hardwired, they can be built with significant flexibility.

The DSP (215) would be either embedded in an ASIC or built out of an FPGA or a separate part of the transceiver. The DSP would be programmed by the MCU (230); if the optional element is included) and interact with the MCU and the hardwired logic. Various forms of coding/decoding, digital filters and FEC functions would be good, in many cases, for the DSP to handle. The DSP has great flexibility but can be difficult to program and is not as fast as hardwired logic so certain functions would be better for hardwired logic or for the optional MCU to handle.

Like the DSP, the optional MCU (230) would be either embedded in an ASIC or built out of an FPGA or a separate part of the transceiver. The MCU can be the overall control element in this architecture. It loads the DSP code, configures the hardwired logic and controls the overall operation. The MCU, if included, code implements the PHY layer according to the needs of the particular PLC application segment (e.g., HPA PHY, etc.).

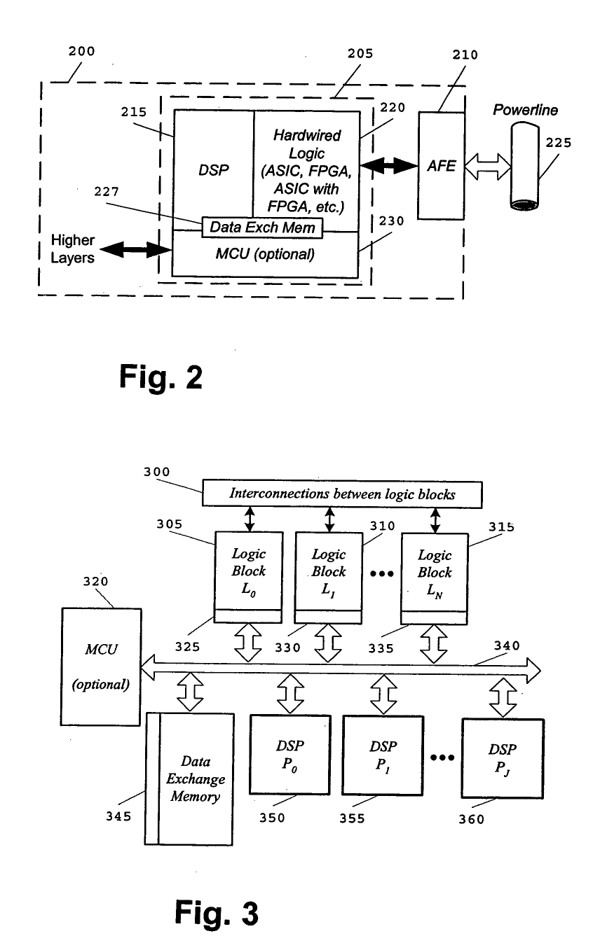

FIG. 3 shows the next level of detail of 205 seen in FIG. 2 in a generalized way. This generalized version shows N logic blocks (305, 310 and 315) interconnected with each other within 300 and each logic block interfaced to the bus (340) by individual interfaces (325, 330 and 335). There are J DSP computational blocks (350, 355 and 360) that are each connected to the bus.

The next level of detail of 205 (FIG. 2) that includes multiple interconnected blocks and is shown in a generalized way in FIG. 3. Each of the N blocks of logic (305, 310 and 315) is interconnected with each other with 300. Additionally, each logic block has an interface (325, 330 and 335) to the bus (340). The interconnections (300) and the interfaces (325, 330 and 335) allow data and control information to be transferred between logic blocks, memory (345) and processors (350, 355, 360 and optional 320). This figure shows J DSP processor blocks (350, 355, and 360) connected to the bus. The bus also has a memory (345) attached for exchanging data between blocks. In this figure, the memory is single port, but it could be implemented with multiple ports to the bus, the DSP blocks and/or optional MCU blocks. This memory could include DMA capability to allow data to be transferred to and from other blocks under hardware control.

2. Block Parameter Resolution

This invention proposes defining a limited range of parameter values for each block mentioned in section 1 so as to encompass the most numbers of PLC application segments. The choice of parameters would be based on the particulars of the PLC applications segment. For example, the HPA specification dictates the parameters for that application segment, while other standards will determine the other parameters. In the event the standards are not settled for a particular PLC application segment, then the range of parameters can be developed.

The HPA specification requires Reed-Solomon and convolutional/Viterbi FEC functions and so this would be part of the options available for (1) and (15). These functions would probably be implemented in a DSP, but a different choice may be more practical depending on the data rates for other PLC application segments, the speeds of available components (e.g., DSP, etc.) and so forth. Furthermore, the FEC function may be implemented in both DSP and hardwired logic depending on the requirements of the PLC application segment. That is, if the data rate were high in one case, then the hardwired logic would be used. If, for another segment, the FEC algorithm is simpler and the data rate is lower, the DSP may be used (this would simplify the development of the hardwired logic). Another likely variation is that for any given algorithm (application segment), a combination of optional MCU, DSP and hardwired logic would be developed to give the highest speed and most flexibility in the implementation.

It is important to reiterate here that functions may be allocated to multiple types of blocks. That is, the hardwired logic might act as a hardware assist to the DSP (or optional MCU), which in combination performs a complete function.

3. Example

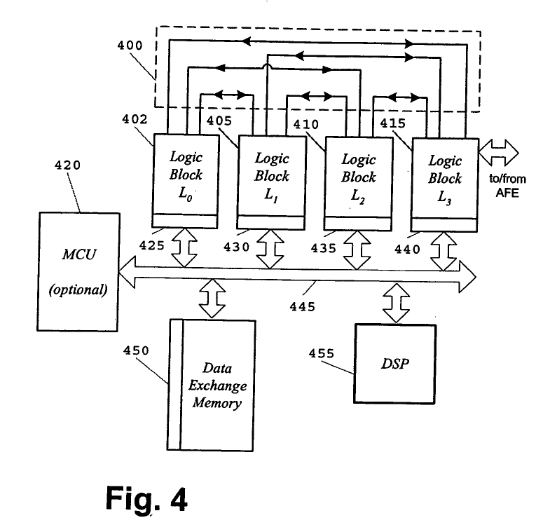

FIG. 4 shows a specific example of the generalized version shown in FIG. 3. In this example, there are four (4) hardwired logic blocks (402, 405, 410 and 415) and bus interfaces (425, 430, 435 and 440 respectively), with a fixed logic block interconnection scheme (400), and a single DSP block (455). This example shows a single DSP (455), a single optional MCU (420), a memory element (450) and four logic blocks (402, 405, 410 and 415) with specific interconnections (400, all blocks connect to every other logic block). In this example, logic block L₃ (415) interacts with the AFE to transfer data and control it (this could be done as a bus interface or as a connection to the DSP in other situations). The MCU, in this example, is responsible for overall control and initializes the DSP block and each of the logic blocks. There are three different software loads in this example—one for in-home operation, one for MDU operation and one for access operation.

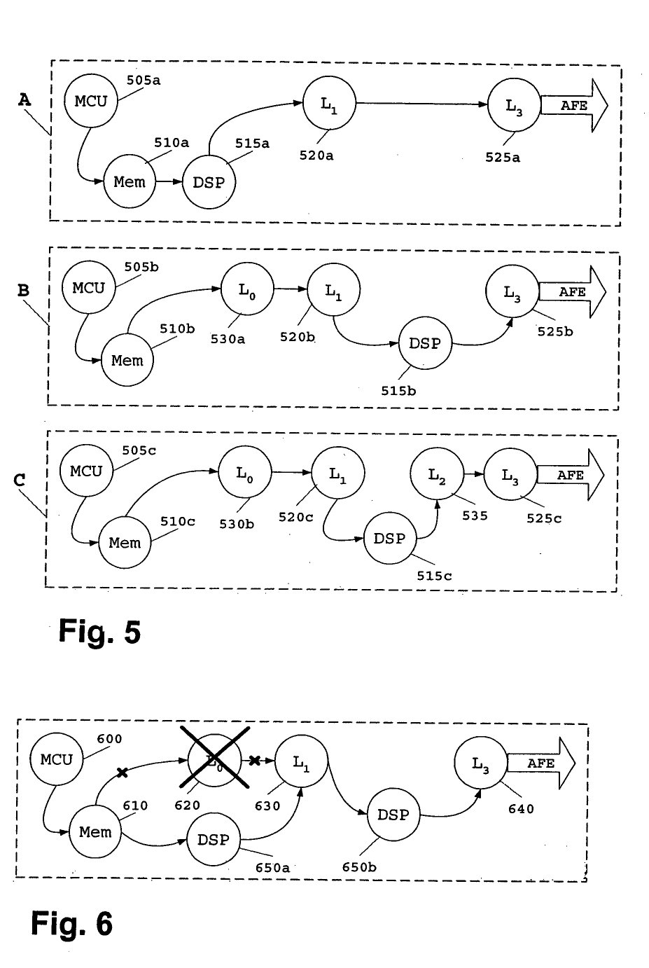

FIG. 5 shows for each of the three operating modes a transmitter data flow diagram, demonstrating a hypothetical data flow for three different program loads—A: In-home operation, B: MDU operation and C: Access operation. In each case, the transmission process begins with the MCU (505a/b/c) depositing data into the memory (510a/b/c) for other blocks to retrieve. The data then proceeds through different blocks, depending on the mode, until it is sent to the AFE (which connects to the powerline for transmission on the network). The important point is that data can flow from logic block to logic block or DSP to logic block or logic block to memory and so on. This flexibility allows using whichever element is best for building the transceiver and using the best communications path to exchange data between blocks.

Another aspect of system flexibility afforded by the architecture is depicted in FIG. 6. Here, a case of FIG. 5 is shown where one of the logic blocks L₀ (620) can no longer be used and must be bypassed. There are many possible reasons for the need to bypass the block including: changes in standards, changes in regulatory requirements, product patches, inserting new product features and so on. The reconfigured system, by a newly designed program load, now uses a DSP routine (650a) which takes data from memory (610), processes it and passes it to block L₁ (630) while block L₀ (620) is disabled.

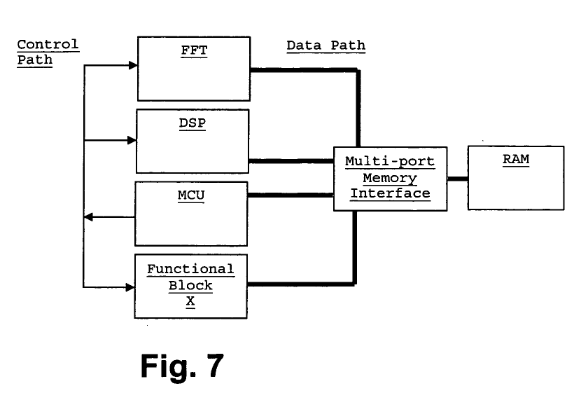

FIG. 7 gives an example of an architecture that is using separate buses for control information and data payload. This architecture can also be applied to PLC transceivers. In this scenario, it can be easily seen that functional blocks can be reconfigured through the control bus to perform a required function, or to adjust the performance of a required function, while leaving the data paths intact.

Overall, the invention provides the following:

1. An architecture for building highly flexible OFDM PLC transceivers that can operate in multiple, diverse, PLC application segments. Transceivers built with this invention can be used in different PLC applications without redesigning them or changing hardware but by changing only the program load.

2. The functional blocks can be implemented in combinations of hardwired logic, DSP code and/or MCU code. The architecture is flexible enough to have functions implemented in several places for different PLC application segments. Additionally, optional MCU, DSP and hardwired logic may be used to implement any single function. This significantly simplifies the overall design and support effort.

3. The highly flexible architecture allows the transceiver to be adapted to changes in technical standards and regulatory standards independent of the implementation technology (i.e., ASIC, FPGA, etc.) just by changing the software load (no hardware changes). Furthermore, product patches, enhancements and new functionality would be incorporated by a new program load.

4. The architecture allows inter-block communications through memory as well as between blocks, all configurable at initialization time.

1. A power line communications transceiver comprising:
a plurality of hardwired logic (HWL) modules coupled to a plurality of digital signal processors (DSPs) in an architecture permitting processing of data and data signals associated with power line communications to be performed at least one of the DSPs and HWL modules, and
a memory including software code for execution by the DSP, wherein the DSP, based on execution of the software code, controls data signal exchange between or among the HWL modules and DSPs and processing of data signals received at and to be transmitted from the transceiver by at least one of the DSPs and the HWL modules.

2. The power line communication transceiver as claimed in claim 1, wherein the transceiver is implemented in PLC technology.

3. The power line communication transceiver as claimed in claim 1, wherein the architecture utilizes a plurality of buses for control information and data payload.

4. The power line communication transceiver as claimed in claim 3, wherein one of the plurality of buses is a control bus.

5. The power line communication transceiver as claimed in claim 4, wherein the architecture includes one or more functional blocks for reconfiguration through the control bus to a required function.

6. The power line communication transceiver as claimed in claim 3, wherein the plurality of buses is a dual bus for control and data.

7. The power line communication transceiver as claimed in claim 6, wherein the architecture is multi-based.
